(19) United States
(12) Patent Application Publication
(10) Pub. No.: US 2008/0192111 A1
(43) Pub. Date: Aug. 14, 2008

(54) Volumetric Display

(75) Inventor: Willem L. Ijzerman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,888

(22) PCT Filed: Jan. 6, 2005
(86) PCT No.: PCT/IB05/50078

§ 371 Date: Dec. 17, 2007

(30) Foreign Application Priority Data
Jan. 9, 2004 (GB) 0400371.1

(51) Int. Cl. H04N 13/04

(52) U.S. Cl. 348/51; 348/E13.075

(57) ABSTRACT

A three-dimensional image display device generates a virtual image within a defined imaging volume. The device includes a two-dimensional image display panel for generating a two-dimensional image; a first focusing element for projecting the two-dimensional image to a virtual image in an imaging volume; and means for altering the effective optical path length between the display panel and the projecting first focusing element so as to alter the position lens of the virtual image within the imaging volume. The effective optical path length may be varied by a lens of variable focal length, by relative motion of the 2D display a panel and the first focusing element, or by the introduction of other optical elements into the optical path that vary the effective optical path length.

The present invention relates to three-dimensional image display devices, and in particular to three-dimensional image display devices that generate a virtual image within a defined imaging volume.

A three-dimensional image can be created in several ways. For instance, in stereoscopic displays two pictures uniquely observable by each of a viewer's eyes can be shown simultaneously or time-multiplexed. The pictures are selected by means of special spectacles or goggles worn by the viewer. In the former case, the spectacles may be equipped with Polaroid lenses. In the latter case, the spectacles may be equipped with electronically controlled shutters. These types of displays are relatively simple to construct and have a is low data-rate. However, the use of special viewing spectacles is inconvenient and the lack of perspective may result in discomfort among viewers.

A more realistic three-dimensional impression can be created using an auto-stereoscopic display. In these types of display, every pixel emits light with different intensities in different viewing directions. The number of viewing directions should be sufficiently large that each of the viewer's eyes sees a different picture. These types of display show a realistic perspective; if the viewer's head moves, the view changes accordingly.

Most of these types of display are technically difficult to realise in practice. Several proposals can be found in the literature, see for instance U.S. Pat. No. 5,969,850. The advantage of these displays is that a number of viewers can watch, e.g. a single 3D television display without special viewing spectacles and each viewer can see a realistic three-dimensional picture including parallax and perspective.

Another type of 3D display is a volumetric display as described at http://www.cs.berkley.edu/jfc/MURI/LC-display. In a volumetric display, points in an image display volume emit light. In this way, an image of a three dimensional object can be created. A disadvantage of this technique is occlusion, i.e. it is not possible to block the light of points that are hidden by other objects. So, every object displayed is transparent. In principle, this problem can be overcome by means of video-processing and possibly tracking of the position of the viewer's head or eyes.

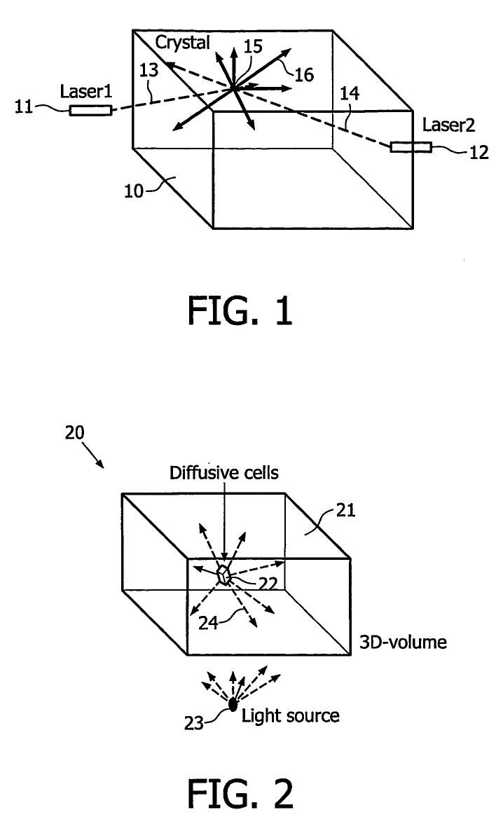

A known embodiment of a volumetric display is shown in FIG. 1. The display consists of a transparent crystal 10 in which two lasers 11, 12 (or more) are scanning. At the position 15 of intersection of the laser beams 13, 14, light 16 may be generated by up-conversion, where photon emission at a higher energy occurs by absorption of multiple photons of lower energy (i.e. from the combined laser beams). This type of display is expensive and complicated. A special crystal 10 and two scanning lasers 11, 12 are required. In addition, up-conversion is not a very efficient process.

An alternative embodiment of volumetric display 20 is shown in FIG. 2. This arrangement uses a material that can be switched between transparent and diffusive, such as polymer dispersed liquid crystal (PDLC) or liquid crystal gel (LC-gel). In a three-dimensional grid volume 21, cells 22 can be switched between these two states. Typically, the volume 21 is illuminated from one direction. In the illustration, the illumination source 23 is located below the grid volume. If a cell 22 is switched to a diffusive condition, light 24 is scattered in all directions.

A still further type of display is described in WO 01/44858. This document describes a three-dimensional volumetric image display device in which collimated light from an illumination source is incident upon a liquid crystal display panel that is superposed with a liquid crystal microlens array. Each microlens in the array is aligned with a respective pixel in the LCD panel to receive light therefrom. Each liquid crystal microlens has an adjustable focal length so that light from the respective pixel may be projected to a selected point in a volumetric image space. Thus, the light intensity and/or colour reaching each microlens in the array may be controlled to produce a plurality of corresponding light intensities and colours in the volumetric image space.

A potential problem with this approach is that each LCD pixel has to be aligned with a respective microlens, and the separation between the LCD panel and the microlens array is fixed in order to determine the depth of the volumetric image space. This results in a very limited viewing angle. In addition, the use of complex microlens arrays is required, together with a complex control system to separately control the focal length of each individual microlens element in the array.

It is an object of the present invention to provide a volumetric three-dimensional image display device that overcomes some or all of the problems associated with prior art devices.

According to one aspect, the present invention provides a display device for generating a three-dimensional volumetric image, comprising:

a two-dimensional image display panel for generating a two-dimensional image;

a first focusing element (42, 47) for projecting the two-dimensional image to a virtual image (40, 45) in an imaging volume (44, 49); and

means (43, 48, 50, 51, 60) for altering the effective optical path length between the display panel and the projecting first focusing element so as to alter the position of the virtual image within the imaging volume.

According to another aspect, the present invention provides a method of generating a three-dimensional volumetric image, comprising the steps of:

generating a two-dimensional image on a two-dimensional image display panel (41, 46);

projecting the two-dimensional image to a virtual image (40, 45) in an imaging volume (44, 49) with a first focusing element (42, 47); and

altering the effective optical path length between the display panel and the projecting focusing element so as to vary the position of the virtual image within the imaging volume.

Embodiments of the present invention will now be described by way of example and with reference to the accompanying drawings in which:

FIG. 1 shows a perspective schematic view of a volumetric display based on two scanning lasers and an up-conversion crystal;

FIG. 2 shows a perspective schematic view of a volumetric display based on switchable cells of polymer dispersed liquid crystal or liquid crystal gel;

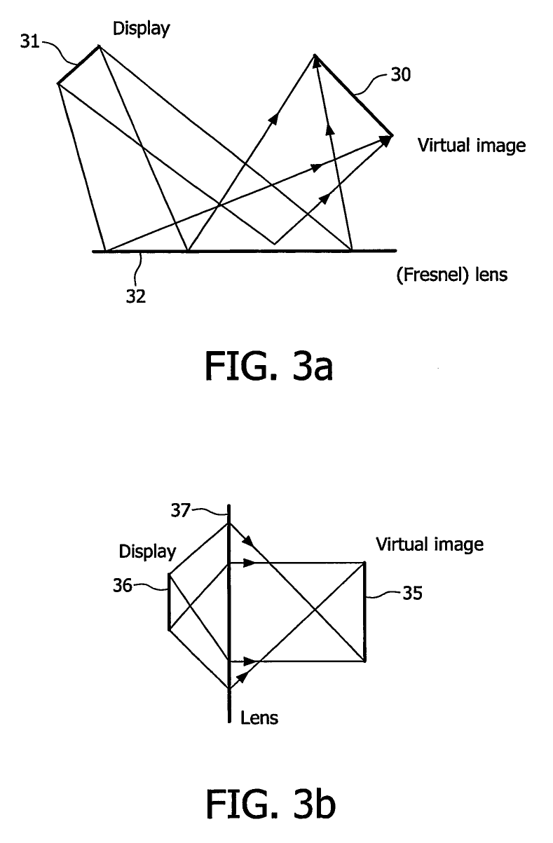

FIG. 3 is a schematic diagram useful in explaining the principles of the present invention;

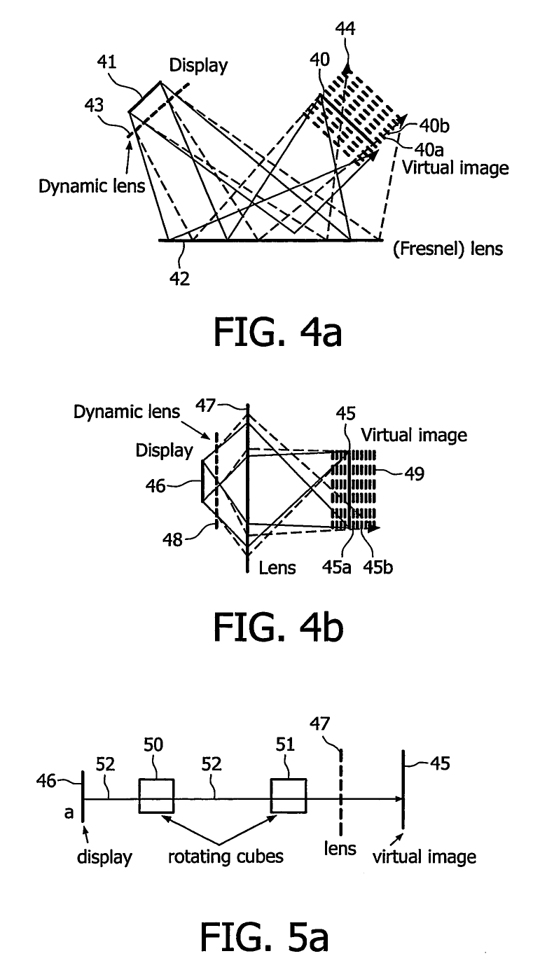

FIG. 4 is a schematic diagram illustrating volumetric three-dimensional image display devices comprising a display panel and a focusing element according to embodiments of the present invention;

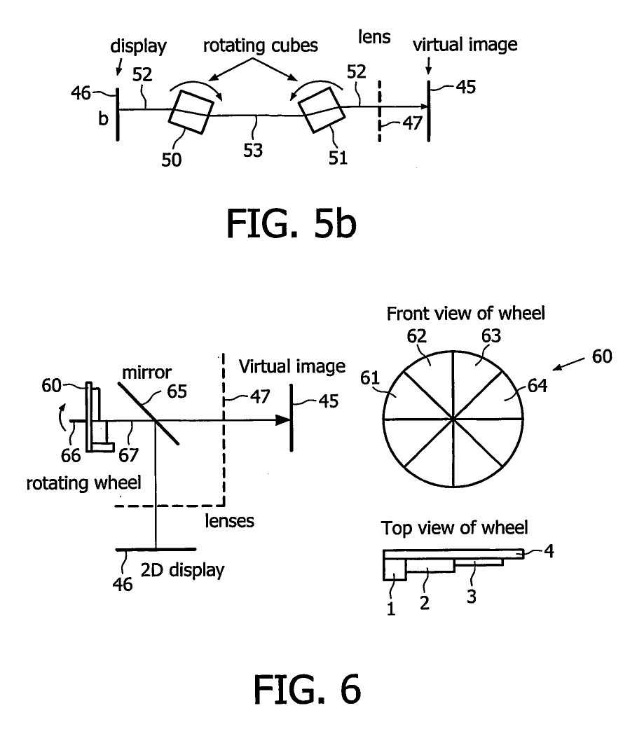

FIG. 5 is a schematic diagram of an arrangement for varying the effective optical path length between the display panel and the focusing element by way of two rotating cubes;

FIG. 6 is a schematic diagram of an arrangement for varying the effective optical path length between the display panel and the focusing element by way of a reflective rotating wheel; and

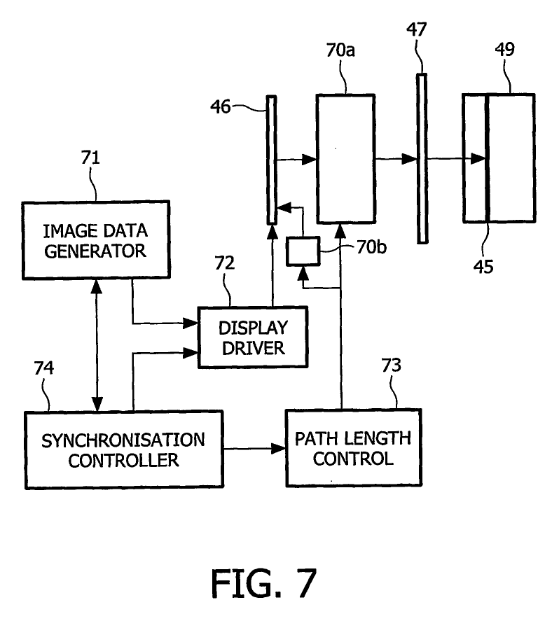

FIG. 7 is a schematic functional block diagram of a control system for the display device of FIG. 4.

FIGS. 3a and 3b illustrate some basic principles used in the present invention. In FIG. 3a, a relatively large virtual image 30 of a small display panel 31 is provided by a Fresnel mirror 32. In FIG. 3b, a relatively large virtual image 35 of a small display panel 36 is provided by a Fresnel lens 37. The virtual image 30 or 35 appears in the air in front of the lens. A spectator can focus on this image 30 or 35 and observes that it is ‘floating’ in the air.

FIGS. 4a and 4b illustrate a modification to the arrangements of FIGS. 3a and 3b, according to the present invention. As shown in FIG. 4a, the effective optical path length between the display panel 41 and the Fresnel mirror 42 is varied by the provision of a dynamic lens 43. Similarly, as shown in FIG. 4b, the effective optical path length between the display panel 46 and the Fresnel lens 47 is varied by the provision of a dynamic lens 48.

The dynamic lens 43 or 48 has a dynamically adjustable optical strength. By weakening the optical strength of this lens, the virtual image 40 or 45 will shift away from the Fresnel lens or mirror 42 or 47. If the adjustable lens 43 or 48 is made stronger, the virtual image 40 or 45 will shift towards the Fresnel lens or mirror. It is noted that the effect of increasing or decreasing the optical power of the dynamically adjustable lens 43 or 48 is to vary the effective optical path length between the display panel 41 or 46 and the to Fresnel lens or mirror, by virtue of localised changes in refractive index within the optical path.

In a general sense, it will be noted that the mirror 42 or lens 47 may generally be replaced or implemented by any optical focusing element for projecting the two dimensional image of the display panel 41, 46 to a virtual image 40 or 45 located within an imaging volume 44 or 49. Preferably, the mirror 42 or lens 47 is a single or compound optical focusing element having a single focal length such that a planar display panel is imaged into a single plane of an-imaging volume.

In operation, the optical strength of adjustable lens 43, 48 or, more generally, the effective optical path length between the two-dimensional display panel 41 or 46 and the focusing element 42 or 47, is adjusted periodically at a 3D image display frame frequency. Typically this would be 50 or 60 Hz. So, during one 3D image frame period (e.g. 1/50 sec), the virtual image of the display panel 41 or 46 fills the imaging volume 44 or 49. Within the same frame period, the display panel may be driven to alter the image that is projected, so that different depths within the imaging volume 44 or 49 receive different virtual images.

It will be understood that in a preferred aspect, the means for altering the effective optical path length between the 2D display panel 41 or 46 and the focusing element 42 or 47 is effective to periodically sweep a substantially planar virtual image of the substantially planar two dimensional display panel through the imaging volume 44 or 49 at a 3D frame rate. Within that 3D frame period, the 2D image display panel displays a succession of 2D images at a 2D frame rate substantially higher than the 3D frame rate.

Therefore, at different planes 40a, 40b or 45a, 45b in the imaging volume 40, 45, different images are obtained so that a three-dimensional image of any object can be constructed.

The two-dimensional display panel may be any suitable display device for creating a two dimensional image. For example, this could be a poly-LED display or a projection display based on a digital micromirror device (DMD).

Preferably, the display panel is sufficiently fast to enable the generation of plural 2D images within one frame period of, e.g. 1/50 sec. For example, commercially available DMDs can reach speeds of 10,000 frames per second. If 24 two-dimensional frames are used to create colour and grey-scale effects and a 3D image refresh rate of 50 Hz is required, it is possible to create eight different image planes 40a, 40b, 45a, 45b in the imaging volume 44, 49 is. The dynamically adjustable lens could be any suitable device such as a liquid crystal adaptive lens, a deformable lens (e.g. deformable electrically, thermally or mechanically), or could be substituted for by a deformable mirror system. Preferably, the dynamically adjustable lens is a single or compound lens having a substantially constant focal length over its entire working area, albeit adjustable focal length. The working area of the focusing element should be sufficiently large to image the entire working display area of the display panel.

In the case of a liquid crystal adaptive lens, this may be achieved with a sheet of material whose refractive index properties can vary as a function of applied electric field. An array of transparent electrodes are provided adjacent to the surface of the sheet, and these are used to locally control the refractive index so that it varies spatially across the sheet and thereby forms a focusing lens of selected focal length. In this embodiment, it will be understood that the effective focal length is varied by electro-optic control.

In the case of a deformable lens or mirror, this may be achieved by an elastic or plastic material of suitable refractive index whose shape may be distorted in order to provide a lens or mirror of selected focal length. In these embodiments, it will be understood that the effective focal length of the focusing element is varied by mechanical means, e.g. by electromechanical, magneto-mechanical or acoustic transducer.

In another embodiment, alteration of the effective length of the optical path between the display panel 41, 46 and the focusing element 42, 47 is achieved by varying the physical path length, as well as or instead of variation in the effective optical path length by refractive index adjustments as already discussed.

Adjustment of the physical distance between the display panel 41, 46 and the focusing element 42, 47 may be achieved mechanically, simply by physical movement of one or the other (or both) of the display panel and the focusing element (i.e. by alteration of their relative positions). This can be by way of a suitable motor drive or vibration mechanism.

FIG. 5 shows an alternative technique for altering the physical path is length. In FIG. 5a, two rotating cubes 50, 51 are positioned in the optical path between the display panel 46 and the focusing element 47. When the two cubes 50, 51 have faces orthogonal to the light path 52, the optical path is undiverted. When the two cubes 50, 51 are contra-rotated slightly as shown in FIG. 5b, a portion 53 of the optical path 52 is diverted slightly downwards as shown. The two cubes are contra-rotated in synchronism such that the light ray leaves the system along the same path. Due to the parallel displacement of the portion 53 of optical path 52 in between the two cubes, the optical distance between the display and the lens can be altered.

In a general sense, it will be understood that the two rotating cubes operate as a pair of displaceable refraction elements for displacing and thereby varying the length of a portion of the optical path.

Another alternative is described in connection with FIG. 6. A segmented wheel 60 has a thickness that varies from segment to segment, e.g. segments 61-64. If the two-dimensional display is imaged via or through the wheel 60, the effective optical path length changes with rotation of the segmented wheel. The 2D display panel 46 is positioned to one side of the main optical path alignment and light therefrom is deflected by half-mirror 65 to the reflective rotating wheel 60. The rotating wheel is driven by a motor 66 and may be configured in several different ways to effect a change in effective path length as a function of rotation.

In a first configuration, the rotating wheel has a reflective upper surface. In this way, light incident on the wheel reflects off an upper surface which is effectively changing in height as the wheel rotates thereby shortening optical path section 67. This affects both the inbound and reflected light beam. The light reflects back to the half-mirror 65 and then continues to the focusing element 47 to form virtual image 45.

In a second configuration, the rotating wheel has a reflective lower surface. In this way, light incident upon the wheel 60 travels through the thickness of the segment 61-64 upon which it is incident and then reflects back to the half-mirror 65. The light then continues to the focusing element 47 to form virtual image 45. In this situation, the effective change in optical path length is altered by the introduction of varying thickness of optical material corresponding to each segment 61-64, each having a higher refractive index than the free space path.

In a third configuration, the same effect could be achieved by the segmented wheel being of constant thickness but with segments of varying refractive index.

Preferably, the optical system comprising the focusing element 47 enlarges the image of the 2D display device. In such a case, only a small adjustment of the distance between the 2D display and the lens results in a large displacement of the virtual image. Let us denote the distance between the 2D display and the lens by o and the distance between the lens and the virtual image by b. Then, there holds the following relation between the lens strength a[m], o[m] and b[m]:

1/f=1/o+1/b

An increase of the object distance by Δo results in an increase of the distance b by Δb:

Δb=−M²Δo

where M=b/o is the magnification factor. Since M is larger than 1, typically, between 5 and 10, a small increase in o results in a large displacement of the virtual image.

The volumetric displays as described herein can generally be simple to construct and can be assembled from well known parts. Applications for such volumetric displays are widespread, including in the professional market, e.g. CAD/CAM and medical applications, and in the domestic market, e.g. for entertainment devices.

With reference to FIG. 7 a schematic view of an overall volumetric image display device with control system is shown. The effective optical path length modifier 70a (such as adaptive lens 43, 48, rotating cubes 50, 51 or segmented wheel 60) interposed between the 2D display panel 46 and focusing element 47 is controlled by path length control circuit 73. Alternatively, a motorised stage 70b for varying the position of the 2D display panel 46 is controlled by the path length control circuit. A display driver 72 receives 2D frame image data from image generator 71. Display of the succession of 2D images is synchronised with the path length controller operation by way of a synchronisation circuit 74.

Other embodiments are intentionally within the scope of the accompanying claims.

1. A display device for generating a three-dimensional volumetric image, comprising:
a two-dimensional image display panel (41, 46) for generating a two-dimensional image;
a first focusing element (42, 47) for projecting the two-dimensional image to a virtual image (40, 45) in an imaging volume (44, 49); and
means (43, 48, 50, 51, 60) for altering the effective optical path length between the display panel and the projecting first focusing element so as to alter the position of the virtual image within the imaging volume.

2. The display device of claim 1 in which the means (43, 48, 50, 51, 60) for altering the effective optical path length is adapted to operate so as to move the virtual image periodically through the imaging volume.

3. The display device of claim 2 further including:
a display driver (72) for controlling the display panel to generate a succession of different images as the virtual images corresponding thereto are moved through the imaging volume; and control means (73, 74) for synchronising the display driver with the means (70) for altering the effective path length.

4. The display device of claim 1 in which the means for altering the effective optical path length comprises a second focusing element (43, 48) having adjustable optical strength.

5. The display device of claim 4 in which the second focusing element (43, 48) is a liquid crystal adaptive lens.

6. The display device of claim 4 in which the second focusing element (43, 48) is a deformable lens.

7. The display device of claim 4 in which the second focusing element (43, 48) is a deformable mirror.

8. The display device of claim 1 in which the means for altering the effective optical path length comprises physical displacement means (70b) for altering the relative positions of the display panel (46) and the first focusing element (42, 47).

9. The display device of claim 1 in which the means for altering the effective optical path length comprises an optical path modifier (50, 51, 60) for varying at least a portion of the optical path between the display panel (46) and the first focusing element (42, 47).

10. The display device of claim 9 in which the optical path modifier (50, 51) is adapted to vary a distance travelled by the light from the display panel (46) to the focusing element (42, 47).

11. The display device of claim 9 in which the optical path modifier (50, 51, 60) is adapted to vary the refractive index of at least a portion of the optical path.

12. The display device of claim 10 in which the optical path modifier comprises a plurality of displaceable refraction elements (50, 51) for displacing and thereby varying the length of a portion (53) of the optical path.

13. The display device of claim 10 in which the optical path modifier is a reflective element (60) having a plurality of portions of differing height which may be selected to reflect the light from the display panel to the focusing element from different physical locations; and
selection means (66) for varying the portion of optical element that lies in the optical path.

14. The display device of claim 11 in which the optical path modifier (60) comprises:
an optical element (60) between the display panel (46) and the first focusing element (47), having a different refractive index than other parts of the optical path between the display panel and the first focusing element, the optical element having portions (60-64) of varying thickness and/or refractive index; and
selection means (66) for varying the portion of optical element that lies in the optical path.

15. The display device of claim 1 in which the first focusing element (42, 47) enlarges the virtual image (40, 45) of the display panel (41, 46).

16. The display device of claim 1 in which the first focusing element (42, 47) projects the two dimensional image into a corresponding planar virtual image (40, 45) in the imaging volume (44, 49), the means for altering the effective path length altering the distance of the planar virtual image from the optical output of the first focusing element (42, 47).

17. The display device of claim 1 in which the display panel (41, 46) is adapted to have an image refresh rate substantially greater than 50 frames per second.

18. The display device of claim 1 in which the display panel (41, 46) is adapted to have an image refresh rate greater than 200 frames per second.

19. The display device of claim 1, in which the means for altering the effective optical path length includes mechanical means.

20. The display device of claim 1, in which the means for altering the effective optical path length includes electro-optical means.

21. The display device of claim 1 in which the first focusing element is a single or compound element having substantially a single focal length.

22. The display device of claim 4 in which the second focusing element is an adjustable, single or compound lens having a substantially constant focal length over its entire working area.

23. A method of generating a three-dimensional volumetric image, comprising the steps of:
generating a two-dimensional image on a two-dimensional image display panel (41, 46);
projecting the two-dimensional image to a virtual image (40, 45) in an imaging volume (44, 49) with a first focusing element (42, 47); and
altering the effective optical path length between the display panel and the projecting focusing element so as to vary the position of the virtual image within the imaging volume.

24. The method of claim 23 including moving the virtual image periodically through the imaging volume.

25. The method of claim 24 further including the steps of:
controlling the display panel to generate a succession of different images as the virtual images corresponding thereto are moved through the imaging volume; and
synchronising the images of the display panel with the periodic movement of the virtual images through the display volume.

26. The method of claim 23 in which the step of altering the effective optical path length comprises varying the optical strength of a second focusing element (43, 48).

27. The method of claim 23 in which the step of altering the effective optical path length comprises altering the relative positions of the display panel (46) and the first focusing element (42, 47).

28. The method of claim 23 in which the step of altering the effective optical path length comprises varying at least a portion of the optical path between the display panel (46) and the first focusing element (42, 47).

29. The method of claim 28 further comprising varying a distance travelled by the light from the display panel (46) to the focusing element (42, 47).

30. The method of claim 28 further comprising varying the refractive index of at least a portion of the optical path.

31. The method of claim 29 further comprising varying the positions of a plurality of displaceable refraction elements (50, 51) for displacing and thereby varying the length of a portion (53) of the optical path.

32. The method of claim 29 further comprising the step of introducing a succession of mirrors into the optical path, each mirror having a different position with respect to an incident optical beam.

33. The method of claim 30 further comprising altering the position of an optical element (60) between the display panel (46) and the first focusing element (47), having a different refractive index than other parts of the optical path between the display panel and the first focusing element, the optical element having portions (60-64) of varying thickness and/or refractive index.

34. The method of claim 23 further including the step of refreshing the image in the display panel at a refresh rate substantially greater than 50 frames per second.

35. The method of claim 34 in which the step of refreshing the image in the display panel is at a refresh rate greater than 200 frames per second.
